(19) United States
(12) Patent Application Publication
(10) Pub. No.: US 2013/0152907 A1
(43) Pub. Date: Jun. 20, 2013

(54) ELECTRONIC INDUCTION SYSTEM TUNING

(71) Applicant: Victoriano Ruiz, Brighton, MI (US)

(72) Inventor: Victoriano Ruiz, Brighton, MI (US)

(73) Assignee: CHRYSLER GROUP LLC, Auburn Hills, MI (US)

(21) Appl. No.: 13/326,918

(22) Filed: Dec. 15, 2011

(51) Int. Cl. F02B 33/32; F04B 37/10

(52) U.S. Cl. 123/559.1; 417/48

(57) ABSTRACT

Electronic induction system tuning featuring electronic pressure charging for an intake tract of an internal combustion engine is disclosed herein. The electronic pressure charging system includes a pressure sensor, a signal generator, and a wave generator. The signal generator causes the wave generator to create a pressure wave in response to monitored parameters and a pressure wave detected by the pressure sensor. The generated pressure wave may be added to, cancel, or otherwise modify the detected pressure wave to increase, decrease, or otherwise manipulate the pressure within a combustion chamber of the engine.

### FIELD

The present disclosure relates to an internal combustion engine induction system and, more particularly, to an internal combustion engine induction system utilizing electronic pressure charging.

### BACKGROUND

A four stroke engine of the kind typically used in automotive engines goes through two crankshaft rotations for each firing event in a given engine combustion chamber. During the first part of the cycle (“intake stroke”), intake valves are opened and a piston descends from the top of the combustion chamber drawing fresh air and fuel into a combustion chamber. Once the piston reaches the bottom of its stroke, the intake valves are closed and the piston begins to rise (“compression stroke”). The compressed air/fuel mixture is ignited in the combustion chamber as the piston reaches the top of the combustion chamber causing the piston to once again descend (“power stroke”). Exhaust valves are opened once the piston reaches the bottom of its stroke and starts to rise once again, thus, forcing the combusted air/fuel mixture out of the combustion chamber through the exhaust valves (“exhaust stroke”). The exhaust valves are closed once the piston reaches the top of the combustion chamber and the cycle repeats itself. In some engines, the exhaust valves may remain open for an initial portion of the intake stroke, thus overlapping in their opening with the intake valves.

The induction system of an internal combustion engine is typically designed to provide as much air into the combustion chamber as possible. During the intake stroke, air rapidly moves from an engine intake manifold, into an intake runner, through the open intake valve, and into the combustion chamber. When the compression stroke begins, the intake valve is shut and the column of air in the intake runner that was moving into the combustion chamber rapidly comes to a halt. This creates a positive pressure at the intake valve that then reverberates back through the intake runner and into the intake manifold. Once in the intake manifold, the positive pressure wave reflects back into the intake runner until it hits the intake valve. The positive pressure wave will reflect back and forth in the intake tract slowly diminishing in amplitude over time. Timing the opening of the intake valve with the arrival of the positive pressure wave at the intake valve can provide additional air/fuel mixture into the combustion chamber, resulting in increased engine efficiency and power.

Conversely, arrival of a negative pressure wave during the time at which the intake valve is open will cause less air/fuel mixture to enter the combustion chamber. The arrival of the positive pressure wave at the intake valve at the correct time is highly dependent on the rotations per minute (“RPM”) of the engine and the geometry of the induction system. Because the timing is dependent, among other things, on engine RPM, the pressure wave generally will only arrive at the intake valve at the proper time for a small portion of the engine's operating range. Mechanically variable geometry induction systems attempt to solve this problem by altering the geometry of the induction system to increase the percentage of the engine's RPM range at which the intake pressure wave arrives at the intake valve while the intake valve is open. However, these systems generally only offer two, or sometimes three different intake tract geometries, still leaving large portions of the engine RPM range in which the positive pressure wave is not advantageously timed. Some infinitely variable geometry intake tracts have been created. However, like intake tracts with only two or three geometries, infinitely variable systems are complex, expensive, bulky, and still cannot optimize the timing of the intake pressure wave with the intake valve opening for all operating conditions. Moreover, the effect of variable geometry systems on the pressure wave is still limited by the physical geometry of the intake tract. Therefore, there is room for improvement in the art.

### SUMMARY

In one form, the present disclosure provides a method of manipulating pressure in an internal combustion engine including a pressure sensor, a signal conditioner, and a wave generator. The method includes sensing a pressure wave using the pressure sensor, communicating the sensed pressure wave to the signal conditioner, and generating an electronic wave form using the signal conditioner in response to the sensed pressure wave. The method also includes transmitting the electronic wave form to the wave generator, and generating a pressure wave using the wave generator and based upon the electronic pressure wave.

In another form, the present disclosure provides an electronic pressure charging system for pressurizing a confined volume. The system includes a first pressure sensor, a signal conditioner, and a first wave generator. The first pressure sensor is configured to detect a first pressure wave, the signal conditioner is configured to generate an electronic waveform in response to the sensed pressure wave, and the first wave generator is configured to generate a pressure wave based upon the electronic waveform generated by the signal conditioner.

Thus, an induction system having electronic pressure charging is provided. The induction system provides for optimizing an intake pressure wave to improve engine efficiency and performance. The induction system is capable of increasing a positive portion of the pressure wave, decreasing a negative portion of the pressure wave, or altering the pressure wave in any desired manner.

Further areas of applicability of the present disclosure will become apparent from the detailed description and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is a diagram of an exemplary electronic pressure charging system according to the principles of the present disclosure;

FIG. 2 is a graph showing exemplary pressure characteristics of a prior art induction system; and

FIG. 3 is a graph showing exemplary pressure characteristics of the electronic pressure charging system of FIG. 1.

### DETAILED DESCRIPTION

Disclosed herein are exemplary embodiments of an induction system which optimizes the intake pressure wave under engine operating and environmental conditions and does not rely on mechanical changes to the geometry of the induction system. The embodiments disclose an induction system that can increase the size of the positive pressure wave, decrease the size of a corresponding negative pressure wave, or alter the intake pressure waves in desirable manners.

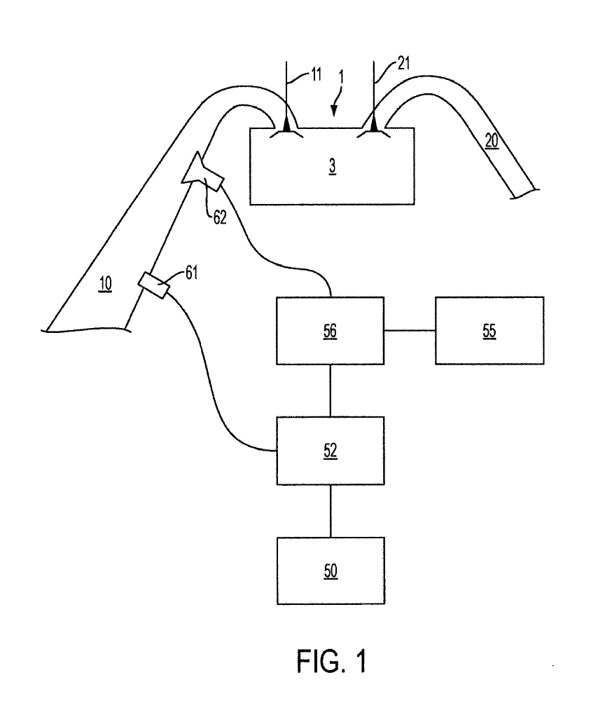

FIG. 1 illustrates an example diagram of an induction system utilizing an electronic pressure charging system according to the principles of the present disclosure. The electronic pressure charging system includes an engine 1 having an intake tract 10. The intake tract 10 feeds atmospheric air, and optionally fuel, through an engine intake valve 11 into the combustion chamber 3 of the engine 1 during the intake stroke of the combustion cycle. The combusted air/fuel mixture is expelled from the combustion chamber 3 through the exhaust valve 21 and exhaust tract 20 during the exhaust stroke of the combustion cycle.

The electronic pressure charging system further includes a pressure sensor 61 mounted in the intake tract 10. In one embodiment, the pressure sensor 61 may be a manifold absolute pressure sensor (“MAP”) of the type typically found on many automotive engines. In one embodiment, the pressure sensor 61 may be any kind of air or other fluid pressure sensor. The pressure sensor 61 is preferably located somewhere in the intake tract 10. In one embodiment, the pressure sensor 61 may be located in an intake manifold or plenum portion of the intake tract 10 that provides an air/fuel mixture to all of the engine's 1 combustion chambers 3. In this embodiment, a single pressure sensor 61 may detect the pressure waves for each of the combustion chambers 3. Alternatively, multiple pressure sensors may be used in the intake manifold or plenum. In one embodiment, the pressure sensor 61 may be located in an individual intake runner that supplies air to a single combustion chamber 3. In this embodiment the pressure sensor 61 may detect the pressure wave for each individual combustion chamber 3. In one embodiment where the pressure sensor 61 is in an individual intake runner, at least one pressure sensor 61 may be employed in each intake runner. It should be appreciated that any number of pressure sensors 61 may be employed and that the pressure sensors 61 may be located anywhere in the intake tract 10. In one embodiment, the location of the pressure sensor 61 is dictated by the geometry of the intake tract 10.

The electronic pressure charging system further includes a signal conditioner 52 coupled to the pressure sensor 61. Calibration adjustments 50 are also coupled to the signal conditioner 52. Calibration adjustments 50 may include sensor inputs such as throttle position, engine load, engine RPM, valve timing, camshaft position, air temperature, and other environmental or vehicle conditions. The signal conditioner 52 analyzes data from the pressure sensor 61 and calibration adjustments 50 and provides a waveform signal to an amplifier 56. The amplifier 56 receives power from a power source 55. The power source 55 may be any type of power source including power sources typically found in a vehicle such as a battery or an alternator. The amplifier 56 amplifies the waveform from the signal conditioner 52 and drives a wave generator 62.

The wave generator 62 may any type of device that is capable of transforming electrical current into a fluid pressure wave such as an electromechanical transducer. In one embodiment, the wave generator 62 may be a piezoelectric crystal. In one embodiment, the wave generator 62 may be a device with a diaphragm similar to an audio speaker. The wave generator 62 is preferably mounted in the intake tract 10 of the engine 1. In one embodiment, there is a single wave generator 62 for each pressure sensor 61. In one embodiment, there may be more than one wave generator 62 for each pressure sensor 61. In one embodiment, there may be more than one pressure sensor 61 for each wave generator 62. In one embodiment, the wave generator 62 may be located in the intake manifold or plenum. In this embodiment, a single pressure sensor 61 and a single wave generator 62 are typically used. The single wave generator 62 generates a pressure wave as needed for each combustion chamber 3. However, more than one pressure sensor 61 and/or wave generator 62 may be utilized as desired. In one embodiment, the wave generator 62 may be located in an individual intake runner that supplies air to a single combustion chamber 3. In this embodiment, there is typically one wave generator 62 and one corresponding pressure sensor 61 in each intake runner for each combustion chamber 3. The corresponding pressure sensor 61 and wave generator 62 produce a pressure wave for their corresponding combustion chamber 3. It should be appreciated that any number of wave generators 62 may be employed and that the wave generators 62 may be located anywhere in the intake tract 10. In one embodiment the location of the wave generator 62 is dictated by the geometry of the intake tract 10.

In operation, the pressure sensor 61 measures the pressure waves in the intake tract 10 and transmits this information to the signal conditioner 52. Using information from the pressure sensor 61, calibration adjustment 50, and preprogrammed information about the geometry of the intake tract, the signal conditioner 52 generates an electronic waveform that is transmitted to the amplifier 56. The amplifier 56 transmits an amplified electronic waveform to the wave generator 62, which turns the amplified electronic waveform into a physical pressure wave. The pressure wave generated by the wave generator 62 is physically superimposed upon the pressure wave detected by the wave detector 61. In one embodiment, the signal conditioner 52 may cause the wave generator 62 to generate a waveform that is in phase with the waveform detected by the pressure sensor 61, thereby, amplifying the pressure wave within the inlet tract 10. For example, the waveform may be generated such that the resultant in-phase amplified positive pressure wave would reach the intake valve 11 at a time when the intake valve 11 is open during the intake stroke portion of the combustion cycle, thereby, causing pressurized air/fuel mixture to enter the combustion chamber 3 and improving engine efficiency and performance. Simultaneously, the resultant in-phase amplified negative portion of the pressure wave may be timed to reach the intake valve 11 when the intake valve 11 is closed, such as during the power stroke, compression stroke, or exhaust stroke. Thus, the lower air/fuel pressure associated with the negative portion of the in-phase pressure wave is avoided in the combustion chamber 3 during the intake stroke portion of the combustion cycle, thereby, avoiding performance or efficiency robbing reduced combustion chamber 3 pressure during the intake stroke.

It should be noted that the generated waveform may be used to create any type of pressure pattern desired in the intake tract 10 at any point during the combustion cycle. In one embodiment, the wave generator 62 may be utilized to reduce or completely cancel out pressure waves within the intake tract 10. To cancel out a pressure wave, the signal conditioner 52 would generate a waveform opposite to that detected by the pressure sensor 61. Thus, the pressure wave detected by the pressure sensor 61 would be completely eliminated or, at the very least, reduced when the opposite waveform generated by the wave generator 62 is superimposed onto the originally detected pressure wave. In one embodiment, the opposite, or cancelling, waveform may be generated to improve engine 1 efficiency. Generating a cancelling waveform and timing the neutralized intake pressure wave with the opening of the intake valve 11 will reduce the pressure in the combustion chamber 3 compared to a positive pressure wave at the same location and time. The reduction in pressure causes less air/fuel mixture to enter the combustion chamber 3, resulting in less fuel being burnt and increased efficiency. In one embodiment, instead of a neutral pressure wave, the wave generator 62 may create an in-phase negative pressure wave such that the resultant superimposed negative pressure wave arrives at the intake valve 11 while the intake valve 11 is open. Thus, pressure in the combustion chamber 3 will be even lower than with the neutralized intake pressure wave, resulting in further improved fuel efficiency. As such, the generated waveform may be utilized to reduce the effective compression ratio of the combustion chamber 3.

In some engines 1, the intake valve 11 and exhaust valve 21 may be open simultaneously for a short portion of time at the end of the exhaust stroke and beginning of the intake stroke. This achieves an effect known as exhaust scavenging in which the combusted air/fuel mixture exiting the combustion chamber 3 through the exhaust valve 21 and exhaust tract 20 literally sucks in new air/fuel mixture through the intake valve 11 and intake tract 10. In such engines 1, it may be desirable to amplify a positive pressure wave during this period of intake valve 11 and exhaust valve 21 overlap by utilizing the electronic pressure charging system to generate an in-phase positive pressure wave resulting in a superimposed large positive pressure wave and, thereby, more effectively expelling the combusted air/fuel mixture from the combustion chamber 3 and drawing into the combustion chamber 3 fresh air/fuel mixture.

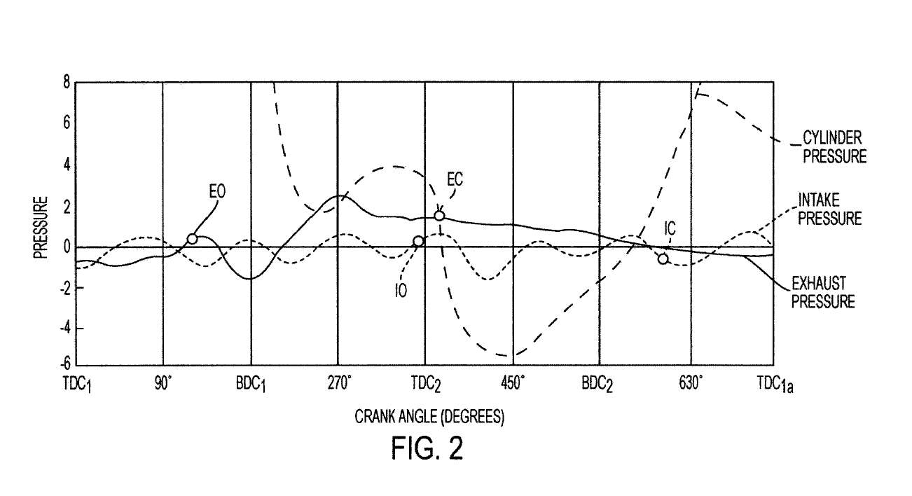

FIG. 2 is a graph showing exemplary pressure characteristics of a prior art induction system. The graph of FIG. 2 depicts the pressure as hypothetically measured at a location in the intake tract 10 (“intake pressure”), the exhaust tract 20 (“exhaust pressure”), and combustion chamber 3 (“cylinder pressure”) throughout the entire combustion cycle for the engine 1 operating at approximately 3,200 RPM. The combustion stroke is located between TDC₁ (top dead center) and BDC₁ (bottom dead center), the exhaust stroke is located between BDC₁ and TDC₂, the intake stroke is located between TDC₂ and BDC₂, and the compression stroke is located between BDC₂ and TDC₁ₐ. TDC₁ₐ is identical to TDC₁ and indicates the restart of the combustion cycle. Also depicted are the exemplary points in the combustion cycle at which the exhaust valve 21 opens (“EO”), the intake valve 11 opens (“IO”), the exhaust valve 21 closes (“EC”), and the intake valve 11 closes (“IC”). As can be seen in FIG. 2, the intake pressure exhibits a repeating oscillation from the time IO to IC. Immediately after IO, the intake pressure experiences an upward oscillation. However, shortly thereafter and before IC, the intake pressure returns to its negative oscillation, thereby hampering the ability for air/fuel mixture to enter the combustion chamber 3 and reducing engine performance.

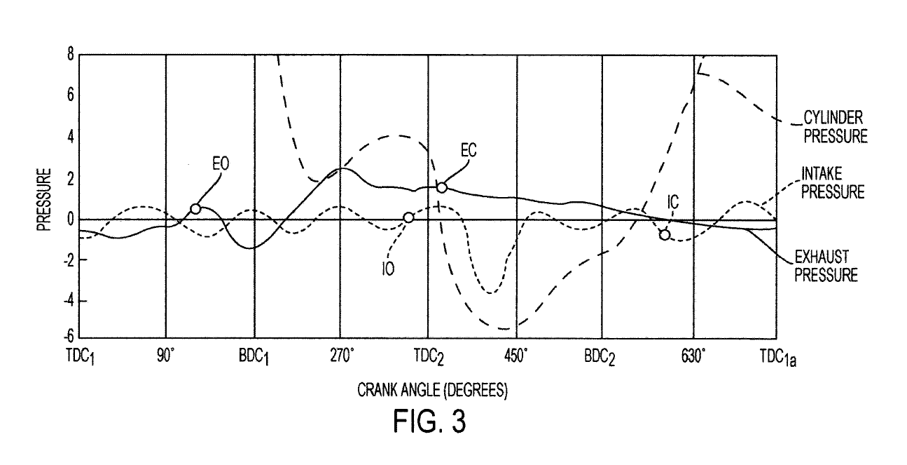

FIG. 3 is a graph showing exemplary pressure characteristics of the electronic pressure charging system of FIG. 1. As in FIG. 2, FIG. 3 depicts the pressure as hypothetically measured at a location in the intake tract 10 (“intake pressure”), the exhaust tract 20 (“exhaust pressure”), and combustion chamber 3 (“cylinder pressure”) throughout the entire combustion cycle for the engine 1 operating at approximately 3,200 RPM. The graph of FIG. 3 is similar to that of FIG. 2. However, between approximately TDC₂ and 450°, the signal conditioner 52 generates an electronic waveform that is transmitted to the amplifier 56. The amplifier 56 transmits an amplified electronic waveform to the wave generator 62, which turns the amplified electronic waveform into a physical pressure wave. The generated pressure wave is superimposed upon the existing intake pressure wave. In the embodiment of FIG. 3, the magnitude of the intake pressure wave is increased to create an increased negative intake pressure wave between TDC₂ and 450°. However, as noted previously, a pressure wave of any magnitude and phase may be generated as desired anywhere in the combustion cycle.

In one embodiment, by timing a positive pressure wave with the opening of the intake valve 11, the electronic pressure charging system achieves an effect similar to turbo charging or supercharging, albeit at a lesser scale. At the same time, the electronic pressure charging system is more energy efficient, less complex, and less costly than supercharging or turbo charging. In one embodiment, the electronic pressure charging system may be used in combination with supercharging and/or turbo charging or any other means of forced induction.

In one embodiment, the signal conditioner 52 may employ adaptive learning control based upon inputs from the calibration adjustment 50 and/or pressure sensor 61. The adaptive control may enable the signal conditioner 52 to continuously adjust the generated waveform to optimize vehicle performance, efficiency, or any other desired operational parameter. The signal conditioner 52 may optimize vehicle operation without the mechanical changes to the intake tract 10 required by prior art systems. In one embodiment, the signal conditioner 52 may be employed to optimize vehicle operation in conjunction with mechanical changes to the intake tract 10 such as a variable geometry intake tract.

It should be understood that the embodiment depicted in FIG. 1 is for representative purposes only. Any number of combustion chambers, intake tracts 10, exhaust tracts 20, intake valves 11, exhaust valves 21, intake manifolds or plenums, intake runners, pressure sensors 61 and wave generators 62 may be used. Moreover, the pressure sensors 61 and wave generators 62 may be located wherever desired to achieve the electronic pressure charging effect. In one embodiment, fuel may be added to intake air anywhere in the intake tract 10. In one embodiment, fuel may be added directly into the combustion chamber 3. In one embodiment, any type of desired fuel may be utilized including, but not limited to, gasoline, diesel, natural gas, propane, hydrogen, or any other fuel source.

In one embodiment, the electronic pressure charging system may be utilized with any type of internal combustion engine including, but not limited to, a two stroke engine, four stroke engine, Atkinson cycle engine, or any other type of internal combustion engine. In one embodiment, the electronic pressure charging system may be utilized in any application in which it is desirable to adjust the pressure of a fluid in a confined area. For instance, the electronic pressure charging system may be utilized in any application featuring an intake tract and a confined volume (combustion chamber), whether or not actual combustion takes place.

Thus, an electronic pressure charging system for optimizing the amount of a fluid in a combustion chamber is provided. The electronic pressure charging system tunes the amount of air in a combustion chamber by altering the pressure waves generated during operation of an engine to achieve a desired level of engine performance and fuel efficiency. The electronic pressure charging system is capable of increasing a positive portion of the pressure wave, decreasing a negative portion of the pressure wave, or altering the pressure wave in any desired manner without requiring physical changes to the geometry of the intake tract.

What is claimed is:

1. A method of manipulating pressure in an internal combustion engine, comprising a pressure sensor, a signal conditioner, and a wave generator, said method comprising:
sensing a pressure wave using said pressure sensor;
communicating said sensed pressure wave to said signal conditioner;
generating an electronic wave form using said signal conditioner in response to said sensed pressure wave;
transmitting said electronic wave form to said wave generator; and
generating a pressure wave using said wave generator based upon said electronic pressure wave.

2. The method of manipulating pressure of claim 1, wherein said generated pressure wave is identical to and in-phase with said sensed pressure wave.

3. The method of manipulating pressure of claim 1, wherein said generated pressure wave is inverse to said sensed pressure wave and, thereby, cancels out said sensed pressure wave.

4. The method of manipulating pressure of claim 1, further comprising sensing a calibration adjustment, wherein said signal conditioner generates said electronic waveform in response to said sensed pressure and said sensed calibration adjustment

5. The method of manipulating pressure of claim 1, further comprising:
providing an intake tract; an intake valve; and a combustion chamber, wherein:
said intake tract is coupled to said combustion chamber to permit flow of a fluid between said intake tract and said combustion chamber, and
said intake valve selectively permits said flow of said fluid between said intake tract and said combustion chamber; and
positioning said pressure sensor and said wave generator in said intake tract.

6. The method of manipulating pressure of claim 5, further comprising sensing a calibration adjustment, wherein said signal conditioner generates said electronic waveform in response to said sensed pressure and said sensed calibration adjustment.

7. The method of manipulating pressure of claim 6, wherein:
said generated pressure wave is superimposed with said sensed pressure wave to cancel a negative pressure of said sensed pressure wave, and
said cancelled pressure of said combined generated pressure wave and said sensed pressure wave reaches said intake valve when said intake valve is configured to permit said flow of said fluid between said intake tract and said combustion chamber.

8. The method of manipulating pressure of claim 6, wherein:
said generated pressure wave is superimposed with said sensed pressure wave to increase the magnitude of a positive pressure of said sensed pressure wave, and
said increased magnitude positive pressure of said combined generated pressure wave and said sensed pressure wave reaches said intake valve when said intake valve is configured to permit said flow of said fluid between said intake tract and said combustion chamber.

9. The method of manipulating pressure of claim 8, further comprising:
providing at least two combustion chambers, a pressure sensor associated with each combustion chamber, and a wave generator associated with each combustion chamber; and
generating said pressure wave individually for each combustion chamber using the associated pressure sensor and wave generator.

10. The method of manipulating pressure of claim 8, further comprising:
providing at least two combustion chambers; and
utilizing a single pressure sensor and a single wave generator to generate said pressure wave for each of said at least two combustion chambers.

11. The method of manipulating pressure of claim 1, said method further comprising:
providing an intake tract, an intake valve, a combustion chamber, an exhaust valve, and an exhaust tract, wherein:
said intake tract is coupled to said combustion chamber to permit flow of a fluid between said intake tract and said combustion chamber, and
said intake valve selectively permits said flow of said fluid between said intake tract and said combustion chamber,
said exhaust tract is coupled to said combustion chamber to permit flow of a fluid between said combustion chamber and said exhaust tract, and
said exhaust valve selectively permits said flow of said fluid between said combustion chamber and said exhaust tract; and
positioning said pressure sensor and said wave generator in said intake tract.

12. An electronic pressure charging system for pressurizing a confined volume, comprising:
a first pressure sensor;
a signal conditioner; and
a first wave generator, wherein:
said first pressure sensor is configured to detect a first pressure wave,
said signal conditioner is configured to generate an electronic waveform in response to said sensed pressure wave, and
said first wave generator is configured to generate a pressure wave based upon said electronic waveform generated by said signal conditioner.

13. The electronic pressure charging system of claim 12, further comprising:
an first intake tract;
a first intake valve; and
a first combustion chamber, wherein:
said first pressure sensor and said first wave generator are located in said first intake tract,
said first intake tract is coupled to said first combustion chamber to permit flow of a fluid between said first intake tract and said first combustion chamber, and
said first intake valve is configured to selectively permit said flow of said fluid between said first intake tract and said first combustion chamber.

14. The electronic pressure charging system of claim 13, further comprising:
a second intake tract;
a second combustion chamber;
a second pressure sensor;
a second wave generator; wherein:
said first pressure sensor is configured to detect a first pressure wave in said first intake tract,
said signal conditioner is configured to generate a first electronic waveform in response to said first sensed pressure wave, and
said first wave generator is configured to generate a first pressure wave in said first intake tract based upon said first electronic waveform generated by said signal conditioner,
said second pressure sensor is configured to detect a second pressure wave in said second intake tract,
said signal conditioner is configured to generate a second electronic waveform in response to said second sensed pressure wave, and
said second wave generator is configured to generate a second pressure wave in said second intake tract based upon said second electronic waveform generated by said signal conditioner.

15. The electronic pressure charging system of claim 13, further comprising:
a second intake tract; and
a second combustion chamber, wherein:
said first pressure sensor is configured to detect a first pressure wave in said first intake tract and a second pressure wave in said second intake tract,
said signal conditioner is configured to generate a first electronic waveform in response to said first sensed pressure wave and a second electronic waveform in response to said second sensed pressure wave, and
said second wave generator is configured to generate a first pressure wave in said first intake tract based upon said first electronic waveform generated by said signal conditioner and a second pressure wave in said second intake tract based upon said second electronic waveform generated by said signal conditioner.

16. The electronic pressure charging system of claim 12, further comprising a calibration adjustment in communication with said signal conditioner.

17. The electronic pressure charging system of claim 16, wherein said calibration adjustment is configured to monitor a plurality of vehicle operating conditions.

18. The electronic pressure charging system of claim 17, wherein said plurality of vehicle operating condition includes at least one condition selected from the group consisting essentially of throttle position, engine load, engine RPM, valve timing, camshaft position, and air temperature.

19. The electronic pressure charging system of claim 12, further comprising:
a first intake tract;
a first intake valve;
a first combustion chamber;
a first exhaust valve; and
a first exhaust tract, wherein
said first pressure sensor and said first wave generator are located in said first intake tract,
said first intake tract is coupled to said first combustion chamber to permit flow of a fluid between said first intake tract and said first combustion chamber,
said first intake valve selectively permits said flow of said fluid between said first intake tract and said first combustion chamber,
said first exhaust tract is coupled to said first combustion chamber to permit flow of a fluid between said first combustion chamber and said first exhaust tract, and
said first exhaust valve selectively permits said flow of said fluid between said first combustion chamber and said first exhaust tract.

20. The electronic pressure charging system of claim 19, further comprising:
a calibration adjustment;
an amplifier; and
a power source, wherein:
said calibration adjustment is in communication with said signal conditioner,
said amplifier is configured to amplify said electronic waveform generated by said signal generator and transmit said amplified waveform to said first wave generator, and
said power source is configured to provide electrical power to run said amplifier.
